(19) United States
(12) Patent Application Publication
(10) Pub. No.: US 2010/0269401 A1
(43) Pub. Date: Oct. 28, 2010

(54) Tackle box storage device

(76) Inventor: Joseph R. Spransy, Parker, CO (US)

Correspondence Address: Joseph R. Spransy, 17327 E. Hawksbead Dr., Parker, CO, 80134, US

(21) Appl. No.: 12/386,722

(22) Filed: Apr. 23, 2009

(51) Int. Cl. A01K 97/06; A01K 97/00

(52) U.S. Cl. 43/57.2

(57) ABSTRACT

A malleable framework that receives an individual fishing leader of any length pre-tied to any type of hook or lure and weight is disclosed. The fishing leader is wrapped on the framework, and the assembly is twisted and rolled suitable for individual storage in a standard tackle box slot, together with hook or lure and weight.

### REFERENCES CITED

| | | |
|---|---|---|
| U.S. Pat. No. 566,595 | August 1896 | Magnuson |
| U.S. Pat. No. 578,458 | March 1897 | Knieriemen |
| U.S. Pat. No. 952,314 | March 1910 | Ellsworth |
| U.S. Pat. No. 1,416,142 | May 1922 | Trumble |
| U.S. Pat. No. 1,932,353 | October 1924 | Pflueger |
| U.S. Pat. No. 2,332,036 | October 1943 | Wilburn |
| U.S. Pat. No. 2,431,821 | December 1947 | Murph |
| U.S. Pat. No. 2,553,097 | May 1951 | Lampe |
| U.S. Pat. No. 2,595,463 | May 1952 | Kamps |
| U.S. Pat. No. 2,596,896 | June 1948 | by Goad |
| U.S. Pat. No. 2,597,304 | May 1952 | Dillingham |
| U.S. Pat. No. 2,670,564 | March 1954 | Keener |
| U.S. Pat. No. 2,716,302 | August 1955 | Dutton |
| U.S. Pat. No. 2,730,833 | January 1956 | Newell |
| U.S. Pat. No. 2,744,353 | May 1956 | Adams |
| U.S. Pat. No. 2,783,875 | March 1957 | Shabarick |
| U.S. Pat. No. 2,789,389 | April 1957 | Moen |
| U.S. Pat. No. 2,791,863 | May 1957 | Sweeney |
| U.S. Pat. No. 2,804,717 | September 1957 | Ripperdan |
| U.S. Pat. No. 2,813,368 | November 1957 | Knowles |
| U.S. Pat. No. 2,826,856 | March 1958 | Marion et al. |
| U.S. Pat. No. 2,879,619 | March 1959 | Peterson |
| U.S. Pat. No. 2,743,546 | October 1951 | by Crist |
| U.S. Pat. No. 3,122,855 | March 1964 | Collier |
| U.S. Pat. No. 3,213,564 | October 1965 | Borell |
| U.S. Pat. No. 3,464,143 | September 1969 | Scott |
| U.S. Pat. No. 3,564,755 | February 1971 | Wallace |
| U.S. Pat. No. 3,890,737 | June 1975 | Jones |
| U.S. Pat. No. 3,890,737 | June 1975 | Jones |
| U.S. Pat. No. 3,991,507 | November 1976 | Bart |
| U.S. Pat. No. 4,006,554 | February 1977 | Tice |
| U.S. Pat. No. 4,036,451 | July 1976 | Pipkin |
| U.S. Pat. No. 4,179,834 | December 1979 | Thomas |
| U.S. Pat. No. 4,281,806 | August 1981 | McMullen |
| U.S. Pat. No. 4,791,752 | December 1988 | Van Kampen |
| U.S. Pat. No. 4,813,173 | March 1989 | Abbotoy |
| U.S. Pat. No., 4,573,284 | April 1984 | Hanson |
| U.S. Pat. No., 4,631,856 | October 1985 | by Born |
| U.S. Pat. No. 5,033,228 | September 1989 | Gallivan |
| U.S. Pat. No. 6,219,958 | February 1997 | Eberts, |

### BACKGROUND OF THE INVENTION

1. Field of the Invention

The present invention relates to a fishing tackle storage device, and more particularly to a malleable framework that may receive several wrappings of an individually pre-tied leader line together with any type of hook or lure and weight.

2. Description of the Prior Art

Fishermen typically pre-tie a plurality of leader lines with fishing tackle, such as hooks, lures and weight (including without limitation split shots, sinkers or sliding weights) prior to their fishing expedition. Of all angling components, fishing line (solid, stranded or monofilament) and leaders have long been exceedingly troublesome to store and transport. The pre-tied leader lines often become inextricably entangled, if they are not securely coiled or held immobile. Additionally, the tangling problem is more acute when storing dual or multi pre-tied leader lines collectively (each having tied thereto two or more hooks and/or lure combinations). Untangling is both time consuming and sometimes futile, and in the process, probable that the hooks embedded in the lures will cause injury to the fisherman. As a result, considerable time and fishing opportunity is lost in replacing broken leaders.

In the past, various devices have been designed to provide a means by which fishing leaders can be stored and transported. Several devices have been patented concerning storage devices for pre-tied leaders, hooks and lures.

U.S. Pat. No. 2,596,896, by Goad, is directed to a storage device for pre-tied leader lines made of a light-weight, preferably round piece of wood, or a like moisture-retaining material having formed multiple lengthwise channels. Each lengthwise channel receives a rubber band to secure the leader lines in place. This round cylinder is designed to receive multiple leader lines which collectively are stored in a larger diameter cylinder which eliminates space storing a pre-tied lure or hook.

U.S. Pat. No. 2,743,546, by Crist is directed to a pre-tied leader storage device made of a sponge-like material capable of receiving a hook. The groove design of the Crist invention does not fully protect the line of the pre-tied leader and cannot store a lure. Moreover, the device mass is designed to receive multiple pre-tied leader lines made of compressible sponge-like material which is cumbersome to use and deformable.

U.S. Pat. No. 6,219,958, by Eberts, is directed to a pre-tied leader line, hook and lure storage device comprising a unitary and homogenous geometrically shaped elastomeric spooling structure having multiple perimeter recesses and each recess having a peg to the line and lure. Again, this device receives multiple leader lines and pre-tied lures or hooks in close proximity to each other which must be carefully kept separated when spooling or un-spooning an individual lure to avoid tangling lines.

U.S. Pat. Nos. 4,573,284, 4,631,856 and 5,033,228, by Hanson, by Born and by Gallivan, respectively, are directed to devices of various shapes and materials, each designed to receive by spooling or wrapping multiple leader lines and lures within close proximity to each other. Each has its own unique advantages, but fails in one common area. When pre-tied leader lines and lures are wrapped or spooled in close proximity with a previously wound leader-lure, it is easy to get tangled and it is easy to get stuck from the hooks of previous wound leader-lures in the process.

U.S. Pat. No. 4,036,451, by Pipkin, is directed to an individual hook and leader storage device which contains a reel in which pre-tied hooks are stored and around which their attached leaders are wound in a common direction after being passed through ports in the reel and in a container in which the reel is attached to a journal, the reel rotates to wind the leaders in response to manual turning of a removable cover on the container or direct manual turning of the reel. This device allows individual storage of a leader line and lure, but is more bulky than the instant invention and will not fit in a tackle box slot. Further, the instant invention is less complex than the Pipkin design, with no moving parts, and is therefore easier to manufacture.

It can be seen that known methods do not address the continuing need for a storage device of simple construction that may individually receive a pre-tied leader line together with weight and artificial bait (lure, jig, spinner, fly, etc.), wherein individual storage of same may occur in a standard tackle box slot designed to receive such.

### SUMMARY OF THE INVENTION

Accordingly, one object of this invention is to provide a novel approach for wrapping the leader line pre-tied to weight and artificial bait in an individual fashion such that storage and transport is compatible with any standard tackle box storage slot.

Another one object of this invention is to provide a novel approach for individually storing a leader line pre-tied to artificial bait (lure, jig, spinner, fly, etc.) and weight, to substantially reduce the risk of entanglement from such tackle being stored together with other leader-lures in close proximity.

Another object of this invention is to provide a simple solution to reduce manufacture costs and offer an economical solution for fishing tackle storage.

A further object of this invention is to provide a wrapping surface for the leader line of soft material, both the post and the end pieces, to minimize fraying wrapped leader lines.

A further object of this invention is to provide a novel leader line storage device to transport and store fishing tackle with leaders having different lengths. Longer leader lines, greater than 15 feet, simply require a stiffer post to accommodate the stacking of stress that accumulates with each wrap.

Yet another object of this invention is to offer a storage device having one of a variety of colors, to enable the fisherman to color code what is stored on each individual wrapping. The fisherman's choice may correlate colors to weight of line, length of line or other categorical grouping.

These and other objects of this invention are achieved by providing a fishing storage device that consists of a framework with two end pieces each shaped in the form of an “X” and a post that joins the two X's about 5 inches apart. Each “X” functions as a cleat to enable the fisherman to belay or wrap the leader onto the device. Once fully wrapped, the entire device and leader wrappings are twisted to remove slack and then rolled into a compact “C” that fits nicely in a standard tackle box slot. Note, the artificial bait connected to the leader extends from the device, but is not actually wrapped onto the device in the wrappings. Therefore, since the weight and artificial are not involved in the actual wrapping any complex shape of the artificial bait may be accommodated with this device for storage.

### BRIEF DESCRIPTION OF SEVERAL VIEWS OF THE DRAWING

A more complete appreciation of the invention and many of the attendant advantages thereof will be readily obtained and better understood by reference to the following detailed description when considered in connection with the accompanying drawings.

FIG. 1 is a front view of the Tackle Box Storage Device. This shows the two end pieces of the device, “X” 1 and “X” 2 and the post 3.

FIG. 2 is a front view of a typical leader line, weight and artificial bait. The leader line begins at one end with a loop 4, it can have a leader line of any length 5, it can have a weight of any type 6 and artificial bait of any type 7 at the other end. FIG. 2 shows a slip-shot lead weight 6 and a spoon as the artificial bait 7.

FIG. 3 is a front view of the Tackle Box Storage Device showing how to begin wrapping a leader line with weight and artificial bait onto the device. The loop 4 of the leader line is slipped over the crossbar tip 8 of “X” 1 and drawn across the front of the device with light tension toward notch 9.

FIG. 4 is a partial view of the invention, showing only “X” 1 and the leader line, weight and lure. This shows the first wrap of the leader line, the horizontal wrap, in which the leader line is wrapped in the two horizontal notches of 9 and 10, respectively.

FIG. 5 is a front view of the Tackle Box Storage Device showing the second wrap of the leader line, the vertical wrap, in which the leader line is wrapped in the two vertical notches 13 of “X” 1 and 14 of “X” 2, respectively. Specifically, FIG. 5 illustrates the transition from the horizontal wrap at notch 9 to the vertical wrap beginning at notch 13, by passing the leader line behind the crossbar tip 11 of “X” 1.

FIG. 6 is a front view of the Tackle Box Storage Device showing the third wrap of the leader line, the twist of “X” 1 and “X” 2.

FIG. 7 is the front view of the Tackle Box Storage Device showing how after the wraps are completed, the post 3, together with the twisted wrappings, are bent into a “C” configuration to compact the assembly to fit into a standard tackle box slot. Note, that a short length of the leader 5 attached to the wrappings extends from the device, including weight 6 and artificial lure 7 and are not wrapped onto the device.

FIG. 8 is an oblique view of the Tackle Box Storage Device showing how the device once compacted into the “C” configuration fits into a standard tackle box slot.

In the described embodiment, the invention is described with a length of 5 inches and with a lightweight construction to accommodate leader lines between 3 and 20 feet. Because many varying and differing embodiments may be made with the scope of the inventive concept herein taught and because many modifications may be made in the embodiment herein detailed in accordance with the descriptive requirements of the law, it is to be understood that the details herein are to be interpreted as illustrative and not in a limiting sense.

### DETAILED DESCRIPTION OF THE INVENTION

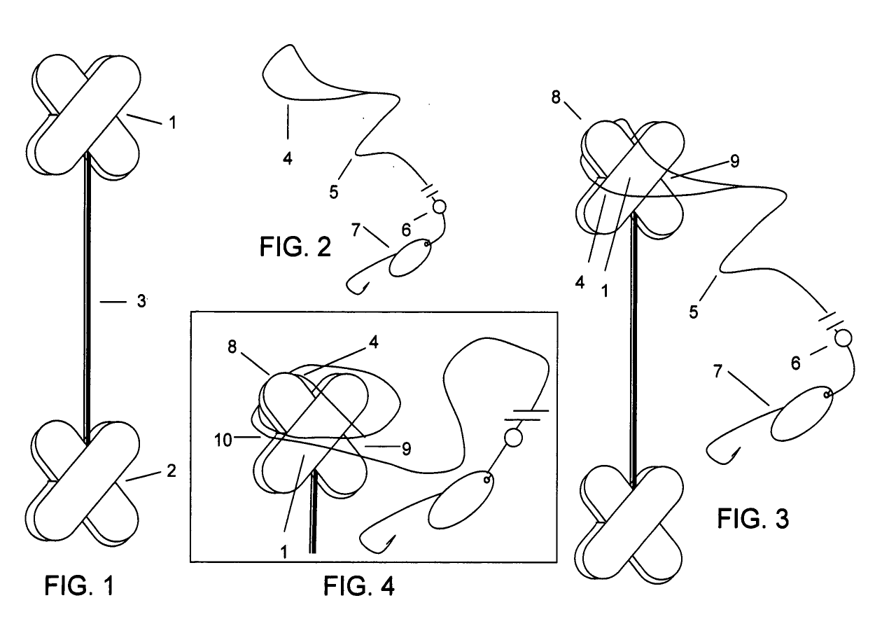

Referring now to the drawings, wherein referenced numerals designate identical or corresponding parts throughout the several views. In reference to FIG. 1, the storage device is seen to include a framework with two end pieces each shaped in the form of an “X”, “X” 1 and “X” 2, and a post 3 that joins the two end pieces about 5 inches apart. The end pieces 1 and 2 may be made of any stiff material, but preferably is made from a stiff plastic with a soft exterior to provide a sturdy cleat to anchor the wrappings to the device and minimize fraying the leader line. The material for the post 3 is be made from any malleable material, but preferably the post is made with material having a metal wire core and a soft outer coating. This provides sufficient stiffness to minimize the post 3 from bending when wrapping leader lines longer than 8 feet. Also, a wire core must be malleable for twisting out all slack in the lines once fully wrapped, shown in FIG. 6, and allows the assembly to be rolled into a “C” configuration, shown in FIG. 7, suitable for storage in a standard tackle box storage slot shown in FIG. 8. Additionally, a post 3 with a metal core provides sufficient durability for repeated use. Also, like the end pieces 1 and 2, the post 3 preferably is made from a material with a soft exterior to minimize fraying the leader line. Finally, the hook from the artificial bait is not designed or required to be plunged into any part of the device. Hence, there is no loss of integrity to the device due to repeatedly use from tearing the invention's material with a hook.

Referring now to FIG. 2, a typical leader will have a loop 4 on one end, a leader 5 which may be of any length (such as but not limited to one to twenty feet), a weight 6 (FIG. 2 feature 6 shows a split shot weight) and artificial bait 7 (FIG. 2, feature 7 shows a spoon) on the other end.

Referring now to FIG. 3, we see how to initially connect the leader to the storage device. The storage device is held vertically with end piece 1 up between the thumb and forefinger at the lower portion of end piece 1. The loop 4 from the leader line is slipped over crossbar tip 8 of end piece 1 and drawn horizontally across the front of the end piece 1 toward notch 9 while maintaining a light even tension of the leader line.

Referring now to FIG. 4, we see how to belay the first wrap, the horizontal wrap, between notches 9 and 10 of the end piece 1. Continue to hold the end piece 1 with your thumb and forefinger, maintaining constant tension on the leader line with your other hand and wrap the leader line through notch 9, wrap behind the end piece 1 into notch 10. Complete the first horizontal wrap by wrapping one or two more times through notches 9 and 10.

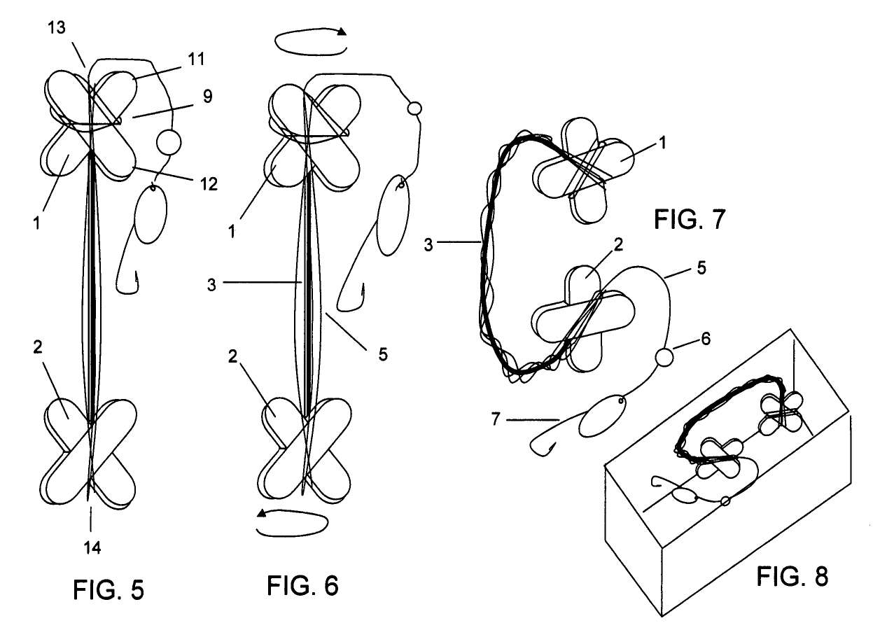

Referring now to FIG. 5, we see how to initiate the second wrap, the vertical wrap, between notch 13 of end piece 1 and notch 14 of end piece 2. From notch 9 of end piece 1, transition to the vertical wrap by bringing the leader line behind crossbar tip 11 of end piece 1 and wrapping the leader line forward through notch 13 of end piece 1. Continue to hold the end piece 1 with your thumb and forefinger, maintaining constant tension on the leader line with your other hand and wrap the leader line down to and through notch 14 of end piece 2. Complete the vertical wrap between notch 13 of end piece 1 and notch 14 of end piece 2 until all but the last six inches of leader line and artificial lure are left. For long leader lines, care must be maintained to avoid bending the post. Bending the post is an indication that too much tension is being applied for the wraps. When weights are firmly attached to the leader line further than six inches from the artificial bait, they should be wrapped onto the device as part of the wrapping.

Referring now to FIG. 6, we see that the wrappings are loosely wound around the device. The slack of the leader line 5 is taken up by the third wrap, the twist. This is accomplished by grasping end piece 1 with your thumb and forefinger from one hand and grasping end piece 2 with your thumb and forefinger from your other hand, then twist each end piece 1 and 2 in an opposite rotation. Specifically, each end piece 1 and 2 is twisted in a clockwise rotation relative to the center of the post 3. Continue twisting until all slack is wrapped tightly around the post 3.

Referring to FIG. 7, once the wrappings of the leader line are tightly wound around the post 3, the device and wrappings are bent or rolled into a “C” configuration, allowing the last length of leader line 5, the artificial bait 7 and in some configurations the weight 6 to extend freely from the wrappings. The object of compacting the wrappings into a “C” configuration is to reduce the size of the assembly so that it may fit in standard tackle box slot, see FIG. 8.

The preferred method for compacting the wrapped leader line and lure to the right size is to place the lure and free leader line into the chosen tackle box slot, then bend your wrappings and device into the “C” configuration to fit in the remaining space of the tackle box slot.

Since the lure is stored individually and separated by a short length of leader (of the fisherman's choosing), any fly, lure, plug, spinner, jig or bare hook may be stored with this device. Furthermore, since each lure is individually joined to its own device, there is no risk to tangling with other artificial lures joined to a common storage device. Also, the fisherman may store each lure in its own separate slot in any brand of tackle box together with a leader line of any typical length. Finally, the post material of the framework may be of different colors to enable the fisherman to color-code their lures, as to weight or length of leader line.

What is claimed as invention is:

1. An individual storage device for pre-tied leader line and artificial bait (e.g., lure, jig, spinner, fly, etc.) or bare hook (with or without weights) consisting of two end pieces and a post.
a. Two end pieces of any suitable shape to function appropriately as a cleat, the preferred embodiment being the shape of an “X”; and
b. A post that joins the two end pieces is made from a stiff material able to withstand the stress of several leader line wrappings and is malleable enough to bend and twist for multiple uses; and
c. The preferred embodiment of the device includes end pieces and a post having material with a soft exterior to avoid fraying the leader line.

2. An individual storage device for pre-tied leader line and artificial bait (e.g., lure, jig, spinner, fly, etc.) or bare hook (with or without weights) that employs a double or triple wrap approach.
a. The double wrap approach begins by looping the leader to an end piece; the first wrap (vertical wrap) is made by wrapping the leader line between the two end pieces until only a short length of leader and artificial bait remains; then the second wrap (the twist) is made by twisting the two end pieces (in a clockwise rotation to the center post) until the slack of the leader line is twisted snuggly around the post;
b. The triple wrap, begins by looping the leader to an end piece; the first wrap (horizontal wrap) is made by wrapping the leader line one or two times between two horizontal notches of the end piece the leader is looped to, to secure the loop; the second wrap (vertical wrap) is made by wrapping the leader line between the two end pieces until only a short length of leader and artificial bait remains; the third wrap (the twist) is made by twisting the two end pieces (in a clockwise rotation to the center post) until the slack of the leader line is twisted snuggly around the post.

3. An individual storage device for pre-tied leader line and artificial bait (e.g., lure, jig, spinner, fly, etc.) or bare hook (with or without weights) when fully wrapped is be bent or rolled into a compact package such as a “C-shape”, suitable for placement into a standard tackle box slot.

4. When the pre-tied leader line and artificial bait are fully wrapped onto to an individual storage device, the artificial bait is not involved in the wrappings therefore, the storage device may accommodate any size or configuration of artificial bait and not interfere with the wrappings of the leader line to the device.

5. When the pre-tied leader line and artificial bait are fully wrapped onto to an individual storage device and the assembly is individually stored in its own tackle box slot, entanglement with other tackle is substantially reduced when compared to devices that are store pre-tied leader lines and artificial bait collectively.

6. The individual storage device for a pre-tied leader line is made of three pieces, does not involve moving parts, is of simple construction and therefore is economical to manufacture.

7. The preferred embodiment uses post material in an assortment of colors to allow the fisherman to color-code his pre-tied leader-lures to his own method of categorizing his tackle (i.e., length of line, weight of line, etc.).
